(19) United States
(12) Patent Application Publication
(10) Pub. No.: US 2009/0126579 A1
(43) Pub. Date: May 21, 2009

(54) POPCORN MACHINES AND OTHER MACHINES HAVING MULTIPLE HEAT ZONE COOKING SURFACES FOR PRODUCING POPCORN AND OTHER TYPES OF EXPANDED FOODS

(76) Inventors: Charles D. Cretors, Lake Forest, IL (US); Nenad Vidojevic, Chesterton, IN (US)

Correspondence Address: PERKINS COIE LLP;PATENT-SEA, P.O. BOX 1247, SEATTLE, WA, 98111-1247, US

(21) Appl. No.: 11/942,648

(22) Filed: Nov. 19, 2007

(51) Int. Cl. A23L 1/18

(52) U.S. Cl. 99/323.11; 426/625

(57) ABSTRACT

Machines having multiple heat zone cooking surfaces for producing popcorn and other types of expanded foods are disclosed herein. In one embodiment, a kettle assembly for popping corn includes a popping surface having a first heat zone adjacent to a second heat zone. In this embodiment, the first heat zone is configured to receive a plurality of unpopped corn kernels, and heat the unpopped corn kernels to a first level. The second heat zone is configured to receive the unpopped corn kernels from the first heat zone, and heat the unpopped corn kernels to a second level, higher than the first level. In one aspect of this embodiment, the kettle assembly can include a first heating element positioned at least proximate to the first heat zone, and a second heating element positioned at least proximate to the second heat zone. The first heating element operates at a first temperature, and the second heating element operates at a second temperature, higher than the first temperature.

### TECHNICAL FIELD

The following disclosure relates generally to systems and methods for popping corn and producing other types of expanded foods.

### BACKGROUND

Popcorn machines for use in theaters, concession stands, and homes are well known. Conventional popcorn machines typically include a popping kettle positioned in a cabinet. To make popcorn, unpopped corn kernels are placed in the kettle with cooking oil and heated with a gas or electric element. The cooking oil coats the kernels and ensures a relatively even distribution of heat throughout the kernel.

Agitating the kernels can prevent them from burning on the bottom of the kettle where the heat is most intense. For this reason, many popcorn machines include some type of agitator that mixes the corn kernels with the cooking oil and ensures even popping. Some machines, for example, include stirring blades that are mounted to a rotating shaft driven by an electric motor. In operation, the stirring blades sweep around the inside of the popping kettle, mixing the kernels with the cooking oil and ensuring the kernels are evenly heated.

As the kernels are heated, they begin to pop. Most conventional kettles have a lid that allows the popped corn to spill out of the kettle as the volume of popped corn increases. When the popping operation is complete, the kettle can be tilted to dump any remaining popcorn onto the floor of the cabinet.

Corn kernels are pressure vessels that consist of about 14% moisture. When heated, the starch in the kernel becomes gelatinized (i.e., a thick liquid) and the moisture turns to steam which raises the internal pressure. When the internal pressure reaches about 135 pounds per square inch (PSI), the kernel explodes. As the kernel explodes, the steam expands and stretches the starch cells as the pressure drops to atmospheric. The temperature drops with the dropping pressure, and the starch freezes into a foam structure having a volume that is about 50 times greater than the original kernel.

Although heat is applied to the outside of the kernel during the popping process, the kernel must be cooked to the core for satisfactory popping. If the kernel is heated too rapidly, the kernel will pop before it is cooked to the core and the center will be hard and unsatisfactory. Conversely, if the kernel is heated too slowly, all the moisture may leak out before it reaches popping pressure.

In conventional popcorn machines, the temperature of the popping surface is thermostatically controlled to a uniform temperature of about 480° F. When corn kernels and oil are poured onto the hot surface, the temperature of the surface initially drops to about 380° F. Over the next three to four minutes, the temperature rises back to approximately 480° F. and the kernels begins to pop. When the kettle is dumped, the cycle starts over again.

In some popcorn machines, the corn kernels are continuously fed onto the popping surface at a relatively low rate over a period of time. Such machines are disclosed in, for example, PCT Patent Application No. PCT/EP2005/009010 (Publication No. WO 2006/021387 A1), filed Aug. 19, 2005 (claiming priority to DE Patent Application No. 10 2004040662.6, filed Aug. 20, 2004), entitled “METHOD AND DEVICE FOR THE PRODUCTION OF EXPANDED FOOD,” which is incorporated herein in its entirety by reference. In this type of machine, there may not be enough mass of corn and oil on the popping surface at start-up to temporarily cool the surface. As a result, the initial kernels are exposed to high temperatures that can cause them to pop too quickly, resulting in popcorn with hard centers. Eventually, the continuous feed of corn kernels causes the temperature of the popping surface to stabilize, and the kettle produces good quality popcorn. However, the initial popping cycle or cycles can produce an unacceptably large amount of poorly popped kernels.

### BRIEF DESCRIPTION OF THE DRAWINGS

FIG. 1 is an isometric view looking upwardly at a popcorn machine having a multiple heat zone kettle assembly configured in accordance with an embodiment of the invention.

FIG. 2 is a cross-sectional isometric view of the multiple heat zone kettle assembly of FIG. 1.

FIG. 3 is an isometric bottom view of a multiple zone heating element assembly configured in accordance with an embodiment of the invention.

FIG. 4 is an isometric top view of the multiple heat zone kettle assembly of FIGS. 1 and 2.

FIG. 5 is a partially schematic isometric view of an expanded food machine having a linear food moving device and a multiple heat zone cooking surface configured in accordance with an embodiment of the invention.

FIG. 6 is a partially schematic cross-sectional view of an expanded food machine having a linear food moving device and a multiple heat zone cooking surface configured in accordance with another embodiment of the invention.

FIG. 7A is a cross-sectional view of a portion of a multiple heat zone kettle assembly configured in accordance with another embodiment of the invention, and FIG. 7B is a top view of the kettle assembly of FIG. 7A.

### DETAILED DESCRIPTION

The following disclosure describes various embodiments of popcorn machines and other machines having multiple heat zone cooking surfaces for producing popped corn, puffed rice, and other types of expanded food. In one embodiment, for example, a popcorn kettle assembly configured in accordance with the present invention has a popping surface with inner and outer heat zones. The inner heat zone operates at a first temperature, and the outer heat zone operates at a second temperature, higher than the first temperature. In operation, unpopped corn kernels and cooking oil are fed onto the inner heat zone at a relatively steady rate, and a rotating mixer moves the kernels outwardly from the lower temperature, inner heat zone to the higher temperature, outer heat zone. The gradual heating prevents the corn kernels from cooking too fast or too slow, resulting in fully expanded popped corn without hard centers.

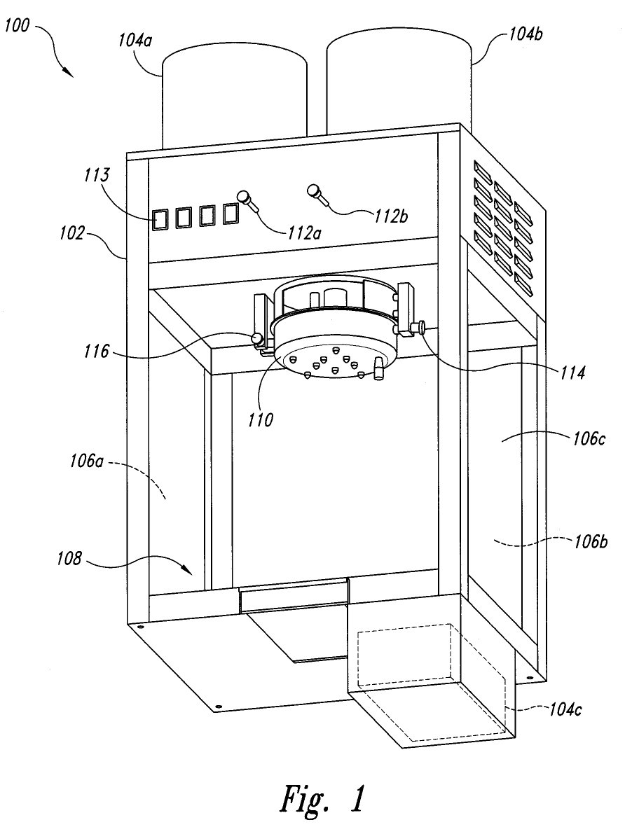

Certain details are set forth in the following description and in FIGS. 1-7B to provide a thorough understanding of various embodiments of the invention. Other details describing well-known structures and systems often associated with popcorn machines, however, have not been set forth in the following disclosure to avoid unnecessarily obscuring the description of the various embodiments of the invention.

Many of the details, dimensions, angles and other features shown in the Figures are merely illustrative of particular embodiments of the disclosure. Accordingly, other embodiments can have other details, dimensions, angles and features without departing from the spirit or scope of the present invention. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refer to the Figure in which that element is first introduced. For example, element 110 is first introduced and discussed with reference to FIG. 1.

FIG. 1 is a bottom isometric view of an expanded food machine 100 configured in accordance with an embodiment of the invention. In the illustrated embodiment, the expanded food machine 100 is a “popcorn machine,” such as a popcorn machine for use in theaters, concession stands, and/or other retail settings. In other embodiments, however, the multiple heat zone features described herein can be incorporated into other types of machines for producing other types of expanded foods, such as puffed rice and the like, in other types of settings, such as commercial settings, residential settings, and the like.

The popcorn machine 100 includes a cabinet 102 having a plurality of see-through side panels 106 (identified individually as side panels 106a-c). A kettle assembly 110 is positioned inside the cabinet 102. Unpopped corn kernels can be stored in a first container 104a positioned on top of the cabinet 102, and flavorings, toppings (e.g., salt, sugar), and/or other ingredients can be stored in a second container 104b. Cooking oil can be stored in a third storage container 104c (e.g. a pail or a “bag in a box”) positioned beneath the cabinet 102. A desired amount of cooking oil can be pumped out of the third storage container 104c and into the kettle assembly 110 by depressing a switch 113 operably connected to a pump (not shown). A desired quantity of corn kernels can be dispensed from the first storage container 104a into the kettle assembly 110 by manipulation of a first control knob 112a. Similarly, a desired amount topping can be dispensed from the second storage container 104b into the kettle assembly 110 by manipulation of a second control knob 112b. As described in greater detail below, as the corn in the kettle assembly 110 begins to pop, it spills out of the kettle assembly 110 and into a holding area 108. Any corn remaining in the kettle assembly 110 after popping can be dumped into the holding area 108 by removing a stop bolt or locking feature 114 and pivoting the kettle assembly 110 downwardly about a joint 116.

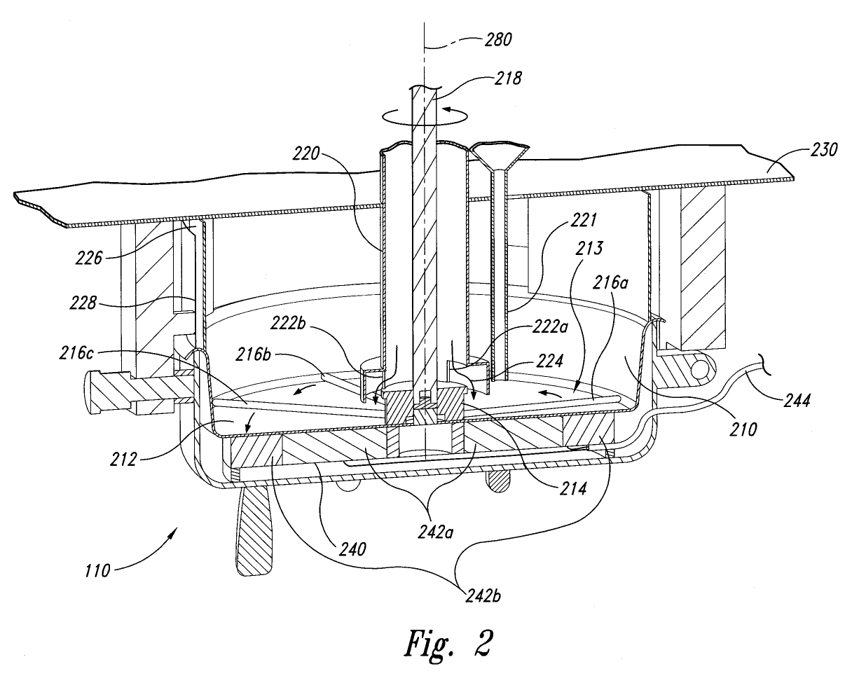

FIG. 2 is a cross-sectional isometric view of the kettle assembly 110 of FIG. 1. By way of example, the kettle assembly 110 can be at least generally similar in structure and function to the kettle assemblies and related devices disclosed in International PCT Patent Application No. PCT/EP2005/009010 (Publication No. WO 2006/021387 A1), filed Aug. 19, 2005 (claiming priority to DE Patent Application No. 10 2004040662.6, filed Aug. 20, 2004), entitled “Method and Device for the Production of Expanded Food,” the disclosure of which is incorporated herein in its entirety by reference. In other embodiments, however, other types of popcorn machines and other machines for making expanded food can utilize the multiple heat zone cooking technology described herein without departing from the spirit or scope of the present disclosure.

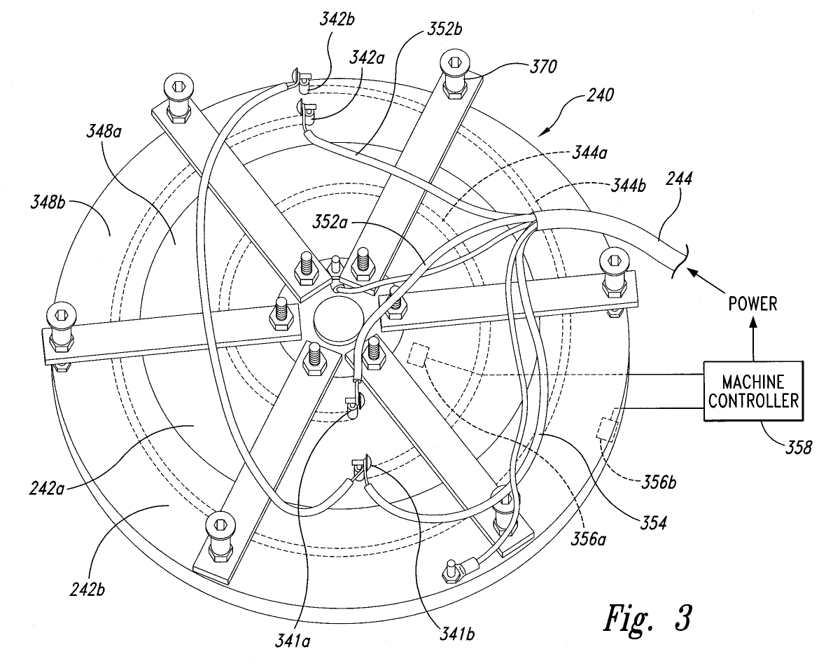

The kettle assembly 110 includes a heating vessel or pan 210 having a popping surface 212 positioned above a heating element assembly 240. As described in greater detail below with reference to FIG. 3, the heating element assembly 240 includes an inner or first heating element 242a and an outer or second heating element 242b. Both of the heating elements 242 receive electrical power via a cord 244.

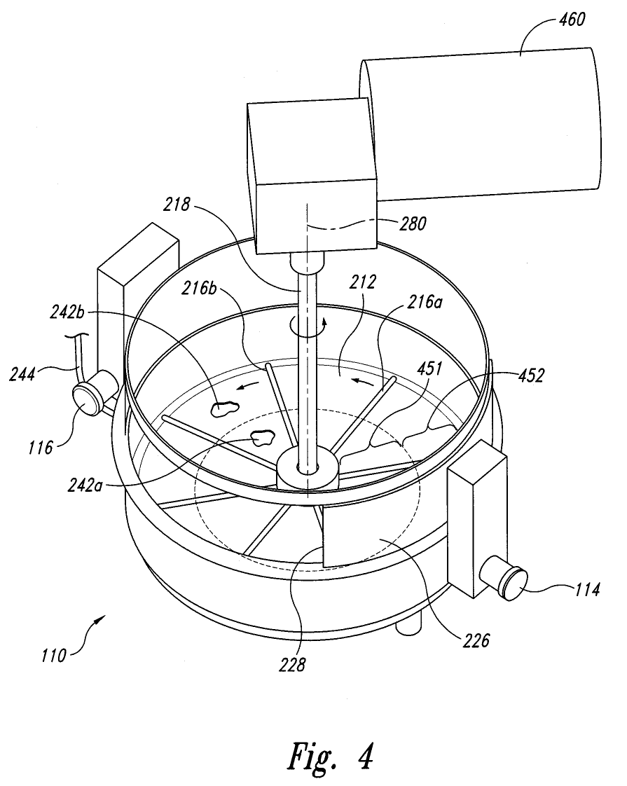

A food moving device 213 is operably positioned inside the pan 210. In the illustrated embodiment, the food moving device 213 includes a plurality of rod-like stirring blades or rakes 216 (identified individually as rakes 216a-i) which extend outwardly from a central hub 214 in a radial pattern. In other embodiments, however, the rakes 216 can include paddle-like surfaces that extend upwardly from the popping surface 212. These surfaces can help push the popped corn out of the kettle assembly 110 after popping. The rakes 216 rotate about a central axis 280 by means of a driveshaft 218 which is operably coupled to the hub 214. The driveshaft 218 is in turn driven by an electric motor (see FIG. 4). A chute or dispenser 220 rides on the hub 214, and includes a first opening 222a and a second opening 222b.

An operator (not shown) can fill the dispenser 220 with a desired amount of unexpanded food particles (e.g., unpopped corn kernels; not shown) from the first storage container 104a by manipulating the first control knob 112a (FIG. 1). During operation of the popcorn machine 100, the kernels flow out of the dispenser 220 and onto the popping surface 212 via the first opening 222a and the second opening 222b as the dispenser 220 rotates about the central axis 280. Cooking oil from the third storage container 104c can be dispensed onto the popping surface 212 via an outlet 221 by depressing the switch 113 (FIG. 1). An upper portion of the kettle assembly 110 includes a cylindrical sidewall 226 that extends between the pan 210 and a top panel 230 of the cabinet 102. An opening 228 in the sidewall 226 permits popped corn to exit the kettle assembly 110 after popping.

FIG. 3 is a bottom isometric view of the heating element assembly 240 of FIG. 2. The first heating element 242a and the second heating element 242b are held in position by a support frame 370. As shown in FIG. 2, the support frame 370 creates a space between the heating element assembly 240 and the bottom portion of the kettle assembly 110. In the illustrated embodiment, the first heating element 242a has a generally round shape, and the second heating element has a generally annular shape that extends around the first heating element 242a. In other embodiments, however, heating element assemblies configured in accordance with the present invention can include other types of heating elements having other shapes, such as rectangular shapes.

The first heating element 242a includes a first resistive wire 344a encased in a first metallic casing 348a. Similarly, the second heating element 242b includes a second resistive wire 344b encased in a second metallic casing 348b. The first resistive wire 344a extends between a first terminal 341a and a second terminal 341b. Similarly, the second resistive wire 344b extends between a third terminal 342a and a fourth terminal 342b. A first positive lead 352a from the power cord 244 is operably connected to the first terminal 341a, and a second positive lead 352b is operably connected to the third terminal 342a. A negative lead 354 from the power cord 244 is operably connected to the second terminal 341b, which in turn is operably connected to the fourth terminal 342b.

In operation, the power cord 244 provides an electrical potential to each of the resistive wires 344. In one embodiment, for example, the power cord 244 provides about 120 volts to each of the resistive wires 344, causing each of the resistive wires 344 to consume about 2150 Watts of electrical power in generating heat. The first heating element 242a and the second heating element 242b can be sized so that each has at least approximately the same surface area adjacent to the popping surface 212 (FIG. 2). As a result, both of the heating elements 242 consume about the same number of Watts-per-square-inch during operation of the heating element assembly 240. In other embodiments, however, the first heating element 242a can have a different surface area adjacent to the popping surface 212 than the second heating element 242b, resulting in different watt-densities between the two heating elements. In still further embodiments, the resistive wires 344 can consume different levels of electric power during operation of the heating element assembly 240. Accordingly, the present invention is not limited to a particular power level or watt density relationship between the heating elements 242.

A first temperature sensor 356a (e.g., a first thermocouple, thermostat, etc.) can be operably positioned at least proximate to the first heating element 242a, and a second temperature sensor 356b can be operably positioned at least proximate to the second heating element 242b. In the illustrated embodiment, the first temperature sensor 356a is positioned on an outer surface of the pan 210 (not shown) near an inboard edge of the first heating element 242a, and the second temperature sensor 356b is positioned on the outer surface of the pan 210 near an outboard edge of the second heating element 242b. In other embodiments, the temperatures sensors 356 can be placed in other locations relative to the heating elements 242 and/or the pan 210. Each of the temperature sensors 356 can be operably connected to a machine controller 358 (e.g., a programmable logic controller). As described in more detail below, the machine controller 358 can regulate or cycle power to the respective heating elements 242 to control the operating temperatures of the heating elements 242 based on temperature input from the corresponding temperature sensors 356. In other embodiments, each of the individual temperature sensors 356 can be operably connected to an individual temperature control circuit for controlling the temperature of the corresponding heating element 242.

FIG. 4 is a top isometric view of the kettle assembly 110 of FIGS. 1 and 2. A number of components of the kettle assembly 110 (such as the kernel dispenser 220 and the oil outlet 221) have been omitted from FIG. 4 for purposes of clarity. At start up, the power cord 244 provides electrical power to the first and second heating elements 242, causing them to heat up. As they heat up, the temperature of each of the heating elements 242 is thermostatically controlled within a desired range so that the popping surface 212 is divided into a first heating region or first heat zone 451 and a second heating region or second heat zone 452. For example, in one embodiment the first heating element 242a can be heated to a first temperature ranging from about 350° F. to about 430° F., e.g., about 380° F., and the second heating element 242b can be heated to a second temperature ranging from about 450° F. to about 500° F., e.g., about 480° F. In other embodiments, other operating temperatures can be selected for the first and second heating elements 242 depending on the particular configuration of the cooking vessel and/or other factors. In still further embodiments, other cooking vessel assemblies configured in accordance with the present invention can include additional heating elements operating at different temperatures to create additional heat zones without departing from the spirit or scope of the present disclosure. For example, other popcorn kettle assemblies configured in accordance with the present invention can include popping surfaces with three or more heat zones.

At start-up, an electric motor 460 rotates the rakes 216 about the central axis 280 as corn kernels and oil (not shown) are fed onto the first heat zone 451 of the popping surface 212. As the rakes 216 rotate, they move the unpopped corn kernels outwardly from the first heat zone 451 toward the second heat zone 452. A suitable rate of rake rotation (e.g., from about 20 revolutions per minute (RPM) to about 60 RPM, e.g., about 40 RPM) in combination with suitable temperatures (e.g., about 380° F. for the first heating element 242a and about 480° F. for the second heating element 242b) can provide favorable heating of the unpopped corn kernels so that they pop with desirable results. As the corn kernels pop, the pan 210 begins to fill up with popped corn. The popped corn ultimately spills out of the pan 210 through the opening 228 in the upper sidewall 226. After the popping cycle, any additional popped corn can be removed from the kettle assembly 110 by loosening the locking feature 114 and rotating the kettle assembly 110 downwardly about the joint 116.

One advantage of the multiple heat zone kettle assembly 110 described above with reference to FIGS. 1-4 is improved popping performance at startup. For example, in some popcorn machines the corn kernels are fed onto the hot popping surface at a relatively low rate. As a result, initially there is an insufficient mass of corn and oil on the surface to temporarily reduce the temperature. Consequently, the first corn kernels onto the popping surface tend to pop too quickly, and they can be very hard as a result of not cooking all the way through. The multi-heat zone cooking surface of the present invention, however, allows the corn kernels to be progressively heated to a suitable temperature for favorable popping. As a result, popping begins with very few poorly popped kernels.

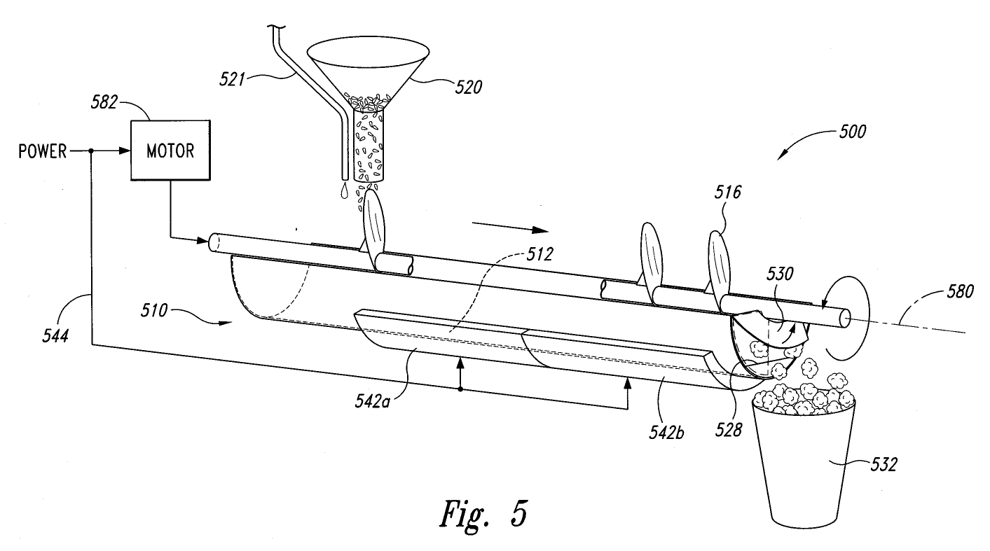

Although the kettle assembly 110 described above with reference to FIGS. 1-4 is generally round, other cooking vessels having other shapes can employ the multi-zone heating technology described herein. FIG. 5, for example, is a partially schematic isometric view of a popcorn machine 500 having a linear cooking vessel assembly 510 configured in accordance with an embodiment of the invention. The cooking vessel assembly 510 includes a first heating element 542a and a second heating element 542b positioned at least proximate to a trough-like popping or cooking surface 512. The heating elements 542 receive electrical power via a power cord 544. Unpopped corn kernels are dispensed onto the cooking surface 512 from a dispenser 520, and cooking oil is dispensed from an outlet 521. A linear moving device 516 (e.g., an auger 516 having a spiral blade) is driven by an electric motor 582 and rotates about a longitudinal axis 580.

In operation, unpopped corn kernels and cooking oil feed onto the cooking surface 512 from the dispenser 520 and the outlet 521, respectively. The auger 516 mixes the corn with the oil, and moves the coated corn kernels along the heated cooking surface 512 toward an outlet 528. In this embodiment, the first heating element 542 can be thermostatically controlled within a first temperature range from about 350° F. to about 430° F., e.g., about 380° F., and the second heating element 542b can be thermostatically controlled within a second temperature range from about 450° F. to about 500° F., e.g., 480° F. As the corn moves along the cooking surface 512, the increasing temperature causes the corn to cook at a suitable rate that results in favorable popping. At the end of the cooking surface 512, the auger 516 drives the popped corn out the opening 528 and into a suitable receptacle 532.

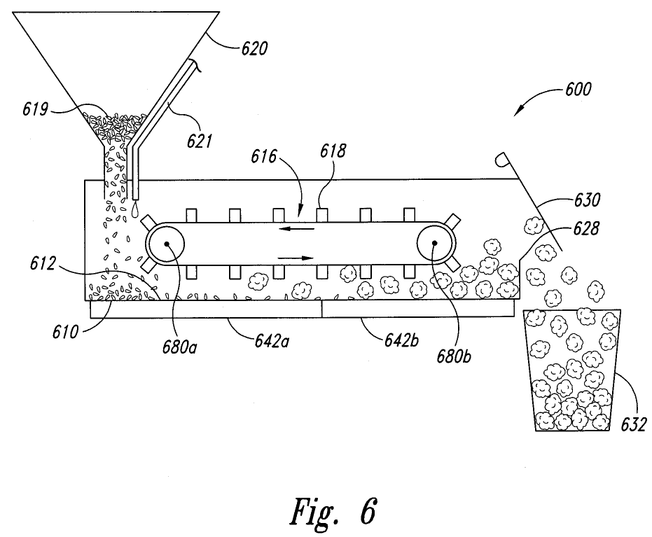

FIG. 6 is a partially schematic, side cross-sectional view of a popcorn machine 600 having a linear cooking vessel assembly 610 configured in accordance with another embodiment of the invention. Many features of the popcorn machine 600 are at least generally similar in structure and function to corresponding features of the popcorn machine 500 described above with reference to FIG. 5. For example, the cooking vessel assembly 610 includes a first heating element 642a and a second heating element 642b positioned at least proximate to a linear cooking surface 612. The first heating element 642a operates at a first temperature, and the second heating element 642b operates at a second temperature, higher than the first temperature. In addition, the cooking vessel assembly 610 also includes a linear food moving device 616. In this particular embodiment, however, the linear food moving device 616 includes a toothed belt 618 that revolves around a first pulley 680a and a second pulley 680b.

In operation, corn kernels from a dispenser 620 and cooking oil from an outlet 621 feed onto a first end of the cooking surface 612. As the revolving belt 618 moves the corn kernels toward a second end of the cooking surface 612, the kernels are progressively heated by the first heating element 642a and the second heating element 642b. As they approach the second end of the cooking surface 612, the kernels pop. The accumulated popped corn at the second end of the cooking surface 612 pushes a flapper door 630 open so that the popcorn can exit through an opening 628 into a suitable receptacle 632.

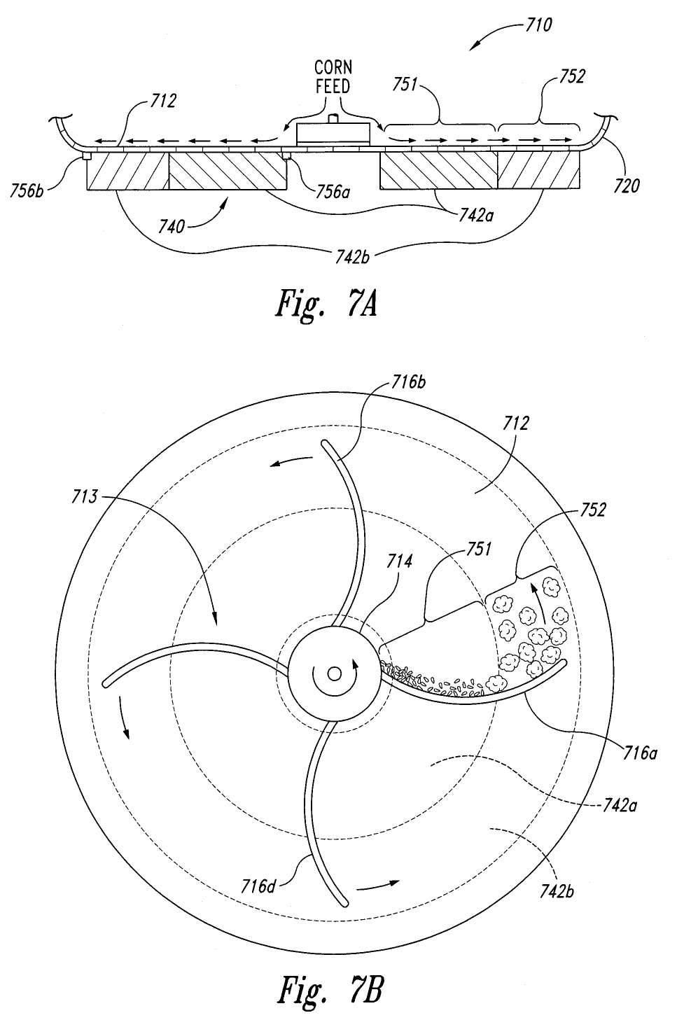

FIG. 7A is a cross-sectional view of a portion of a multiple heat zone kettle assembly 710 configured in accordance with another embodiment of the invention. Many features of the kettle assembly 710 are at least generally similar in structure and function to corresponding features of the kettle assembly 110 described above with reference to FIG. 2. For example, the kettle assembly 710 includes a heating element assembly 740 positioned adjacent to a pan 720 having a popping surface 712. The heating element assembly 740 includes a first heating element 742a and a second heating element 742b. A first temperature sensor 756a is positioned at least proximate to the pan 720 and an inner edge of the first heating element 742a, and a second temperature sensor 756b is positioned at least proximate to the pan 720 and an outer edge of the second heating element 742b. Like the heating element assembly 240 described above, the temperature sensors 756 are used to thermostatically control the temperatures of the heating element 742 during operation of the kettle assembly 710.

FIG. 7B is a top view of the kettle assembly 710 illustrating a food moving device 713 configured in accordance with another embodiment of the invention. Like the food moving device 213 described above with reference to FIG. 2, the food moving device 713 includes a plurality of rakes or blades 716 (identified individually as blades 716a-d) which extend outwardly from a central hub 714. In operation, the blades 716 rotate about a central axis 780 to progressively move unpopped corn kernels across the popping surface 712 from a low temperature first heat zone 751 to a higher temperature second heat zone 752. In this particular embodiment, each of the blades 716 has a non-linear shape that is slightly curved in the direction of rotation as illustrated in FIG. 7B. Curving the blades 716 in this manner can facilitate outward movement of the corn kernels. As those of ordinary skill in the art will appreciate, however, other embodiments of the invention can include rakes or blades having other suitable shapes without departing from the spirit or scope of the present disclosure. For example, as explained above with reference to FIG. 4, in other embodiments the blades 716 can include paddles that extend upwardly from the popping surface 212 to move the popped corn out of the kettle assembly 710 after popping.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

I/We claim:

1. A kettle assembly for popping corn, the kettle assembly comprising:
a popping surface, wherein the popping surface includes:
a first heat zone configured to receive a plurality of unpopped corn kernels and heat the unpopped corn kernels to a first level; and
a second heat zone positioned adjacent to the first heat zone, wherein the second heat zone is configured to receive the unpopped corn kernels from the first heat zone and heat the unpopped corn kernels to a second level, higher than the first level.

2. The kettle assembly of claim 1, further comprising:
a first heating element positioned at least proximate to the popping surface and adjacent to the first heat zone; and
a second heating element positioned at least proximate to the popping surface and adjacent to the second heat zone, wherein the first heating element operates at a first temperature and the second heating element operates at a second temperature, higher than the first temperature.

3. The kettle assembly of claim 1, further comprising a corn kernel dispenser positioned adjacent to the first heat zone, wherein the first heat zone receives the plurality of unpopped corn kernels from the corn kernel dispenser during operation of the kettle assembly.

4. The kettle assembly of claim 1, further comprising a corn kernel dispenser positioned toward a center portion of the popping surface, wherein the first heat zone receives the plurality of unpopped corn kernels from the corn kernel dispenser during operation of the kettle assembly.

5. The kettle assembly of claim 1, further comprising a food moving device positioned at least proximate to the popping surface, wherein the food moving device automatically moves the unpopped corn kernels from the first heat zone to the second heat zone.

6. The kettle assembly of claim 1 wherein the popping surface further includes a third heat zone positioned adjacent to the second heat zone, wherein the third heat zone is configured to receive the unpopped corn kernels from the second heat zone and heat the unpopped corn kernels to a third level, higher than the second level.

7. The kettle assembly of claim 1 wherein the popping surface includes a plurality of heat zones that gradually increase the temperature of the unpopped corn kernels as the unpopped corn kernels move from the first heat zone to the last heat zone.

8. An apparatus for producing expanded food by the application of heat, the apparatus comprising:
a cooking surface that receives a plurality of unexpanded food particles;
a first heating element positioned at least proximate to a first portion of the cooking surface, wherein the first heating element operates at a first temperature to heat the unexpanded food particles to a first level; and
at least a second heating element positioned at least proximate to a second portion of the cooking surface that receives the unexpanded food particles from the first portion of the cooking surface, wherein the second heating element operates at a second temperature to heat the unexpanded food particles to a second level, different than the first level.

9. The apparatus of claim 8, further comprising an automatic food mover positioned adjacent to the cooking surface, wherein the automatic food mover automatically moves the unexpanded food particles from the first portion of the cooking surface toward the second portion of the cooking surface.

10. The apparatus of claim 8, further comprising a rotating food mover positioned adjacent to the cooking surface, wherein the rotating food mover automatically moves the unexpanded food particles radially outward from the first portion of the cooking surface toward the second portion of the cooking surface.

11. The apparatus of claim 8, further comprising a linear food mover positioned adjacent to the cooking surface, wherein the linear food mover automatically moves the unexpanded food particles in a linear direction from the first portion of the cooking surface toward the second portion of the cooking surface.

12. The apparatus of claim 8 wherein the second heating element operates at a second temperature, greater than the first temperature, to heat the unexpanded food particles to a second level, higher than the first level.

13. The apparatus of claim 8 wherein the second heating element is positioned around the first heating element.

14. The apparatus of claim 8 wherein the first heating element has a first shape that is at least approximately circular, and wherein the second heating element has a second shape that extends at least approximately around the first heating element.

15. The apparatus of claim 8 wherein the first heating element has a first surface area positioned at least proximate to the first portion of the cooking surface, wherein the second heating element has a second surface area positioned at least proximate to the second portion of the cooking surface, and wherein the first surface area is at least approximately equivalent to the second surface area.

16. The apparatus of claim 8:
wherein the first portion of the cooking surface is configured to receive a plurality of unpopped corn kernels;
wherein the first heating element heats the unpopped corn kernels to a first temperature, the first temperature ranging from about 350° F. to about 430° F.; and
wherein the second heating element raises the temperature of the unpopped corn kernels from the first temperature to a second temperature, the second temperature ranging from about 450° F. to about 500° F.

17. An apparatus for making popcorn, the apparatus comprising:
a cabinet;
a kettle assembly positioned within the cabinet, the kettle assembly including:
a popping surface;
a first heating element positioned at least proximate to a first portion of the popping surface, wherein the first heating element operates at a first temperature to heat the first portion of the popping surface to a first level;
a second heating element positioned at least proximate to a second portion of the popping surface, wherein the second heating element operates at a second temperature to heat the second portion of the popping surface to a second level, higher than the first level; and
a food moving device positioned adjacent to the popping surface, wherein the food moving device automatically moves unpopped corn kernels from the first portion of the popping surface to the second portion of the popping surface during operation of the apparatus.

18. The apparatus of claim 17, further comprising:
a corn storage container positioned above the cabinet; and
a passage that directs corn kernels from the storage container onto the first portion of the popping surface.

19. The apparatus of claim 17, further comprising a motor operably coupled to the food moving device, wherein operation of the motor causes the food moving device to rotate over the popping surface, thereby moving unpopped corn kernels from the first portion of the popping surface to the second portion of the popping surface.

20. The apparatus of claim 17, further comprising:
a motor; and
a drive shaft operably coupled to the motor, wherein the food moving device includes at least one rake operably coupled to a distal end portion of the drive shaft, and wherein rotation of the drive shaft about a central axis causes the rake to rotate across the popping surface, thereby moving unpopped corn kernels from the first portion of the popping surface to the second portion of the popping surface.

21. A method of popping corn, the method comprising:
heating a first portion of a popping surface to a first temperature;
heating a second portion of the popping surface to a second temperature, higher than the first temperature;
placing a plurality of unpopped corn kernels onto the first portion of the popping surface to heat the unpopped corn kernels to a first level; and
automatically moving the unpopped corn kernels from the first portion of the popping surface toward the second portion of the popping surface to raise the temperature of the unpopped corn kernels from the first level to a second level, higher than the first level.

22. The method of claim 21 wherein placing a plurality of unpopped corn kernels onto the first portion of the popping surface includes automatically dispensing an at least approximately steady flow of unpopped corn kernels onto the first portion of the popping surface.

23. The method of claim 21 wherein placing a plurality of unpopped corn kernels on the first portion of the popping surface includes dispensing the unpopped corn kernels onto a central portion of the popping surface, and wherein automatically moving the unpopped corn kernels from the first portion of the popping surface toward the second portion of the popping surface includes automatically moving the unpopped corn kernels radially outward from the first portion of the popping surface toward the second portion of the popping surface.

24. A system for producing popcorn, the system comprising:
means for heating a first portion of a popping surface to a first temperature;
means for heating a second portion of the popping surface to a second temperature, higher than the first temperature;
means for placing a plurality of unpopped corn kernels onto the first portion of the popping surface to heat the unpopped corn kernels to a first level; and
means for automatically moving the unpopped corn kernels from the first portion of the popping surface toward the second portion of the popping surface to raise the temperature of the unpopped corn kernels from the first level to a second level, higher than the first level.

25. The system of claim 24 wherein the means for placing a plurality of unpopped corn kernels onto the first portion of the popping surface includes means for dispensing an at least approximately steady flow of unpopped corn kernels onto the first portion of the popping surface.

26. The system of claim 24 wherein the means for heating a first portion of a popping surface to a first temperature includes a first circular heating element, and wherein the means for heating a second portion of the popping surface to a second temperature, higher than the first temperature, includes a second circular heating element that extends at least approximately around the first heating element.
